(19) United States
(12) Patent Application Publication
(10) Pub. No.: US 2016/0319130 A1
(43) Pub. Date: Nov. 3, 2016

(54) NOVEL COMPOUND, PHOTOSENSITIVE RESIN COMPOSITION FOR COLOR FILTER COMPRISING THE SAME AND COLOR FILTER

(71) Applicant: Samsung Display Co., Ltd, Yongin-si (KR)

(72) Inventors: Dae Won LEE, Asan-si (KR); Hyun Jin KIM, Pohang-si (KR); Soon Young KIM, Suwon-si (KR); Chul HUH, Yongin-si (KR)

(21) Appl. No.: 15/068,791

(22) Filed: Mar. 14, 2016

(30) Foreign Application Priority Data
Apr. 30, 2015 (KR) 10-2015-0062083

(51) Int. Cl. C09B 47/04; G02B 5/22; C07F 3/06

(52) U.S. Cl. CPC C09B 47/04; C07F 3/06; G02B 5/223

(57) ABSTRACT

There are provided a compound represented by the following Chemical Formula 1, a photosensitive resin composition for a color filter comprising the same, and a color filter manufactured using the photosensitive resin composition for a color filter.

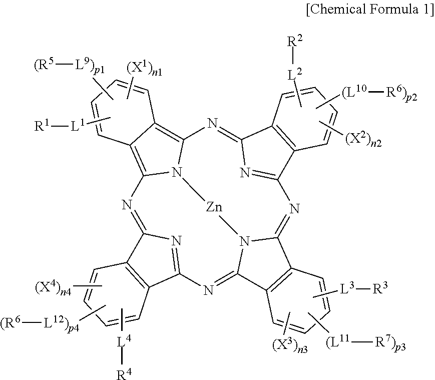

(in Chemical Formula 1, each substituent is as defined in the specification.)

### CROSS-REFERENCE TO RELATED APPLICATION

This application claims priority to and the benefit of Korean Patent Application No. 10-2015-0062083 filed in the Korean Intellectual Property Office on Apr. 30, 2015, the entire contents of which are incorporated by reference herein.

### BACKGROUND

(a) Field of the Invention

The present invention relates to a novel compound, a photosensitive resin composition for a color filter comprising the same, and a color filter.

(b) Description of the Related Art

A color filter is manufactured by applying, developing, and curing a composition composed of a coloring agent, a binder resin participating in forming a film, an initiator contributing to polymerization, and other additives on a substrate. A pigment is mainly used as the coloring agent. Recently, as the requirement for a high end (high color purity, high transmittance) product has increased, the development of an excellent dye having high color purity and high transmittance characteristics, and the like, has been urgently demanded. The pigment currently mainly used as a coloring agent has excellent durability due to excellent cohesion characteristics between molecules, such that the pigment has been widely commercialized, but in view of the material, there is a limitation in implementing high transmittance due to a size limitation of pigment particles. On the contrary, the dye has excellent color characteristics (transmittance, contrast ratio, and solubility) as compared to the pigment, but has a disadvantage in that durability against heat and light is deteriorated. Therefore, there is a need for a high transmittance dye compound capable of improving durability. The above information disclosed in this Background section is only for enhancement of understanding of the background of the invention and therefore it may contain information that does not form the prior art that is already known in this country to a person of ordinary skill in the art.

### SUMMARY

The present invention has been made to provide a novel compound.

In addition, the present invention has been made to provide a photosensitive resin composition for a color filter comprising the compound.

Further, the present invention has been made to provide a color filter manufactured using the photosensitive resin composition.

An exemplary embodiment of the present invention provides a compound represented by the following Chemical Formula 1.

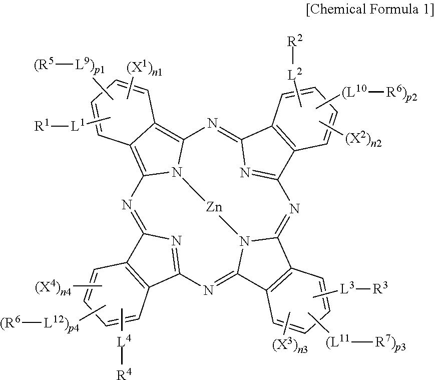

In Chemical Formula 1,

L¹ to L⁴ and L⁹ to L¹² are each independently —O— or —S—,

X¹ to X⁴ are each independently F or Cl.

n1 to n4 are each independently an integer of 0 or 1,

p1 to p4 are each independently an integer of 0 or 1, and

R¹ to R⁸ are each independently represented by the following Chemical Formula 2,

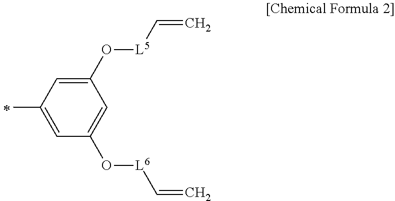

in Chemical Formula 2,

L⁵ and L⁶ are each independently a substituted or unsubstituted C1 to C20 alkylene group or divalent substituted or unsubstituted C1 to C20 alkylether group.

L⁵ and L⁶ may be each independently represented by the following Chemical Formula 3 or 4.

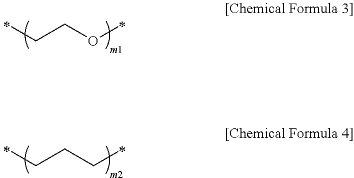

In Chemical Formulas 3 and 4,

m1 and m2 are each independently an integer of 1 to 6.

m1 and m2 may be each independently an integer of 3 to 6.

The compound represented by Chemical Formula 1 may be represented by any one selected from the group consisting of the following Chemical Formulas 5 to 12.

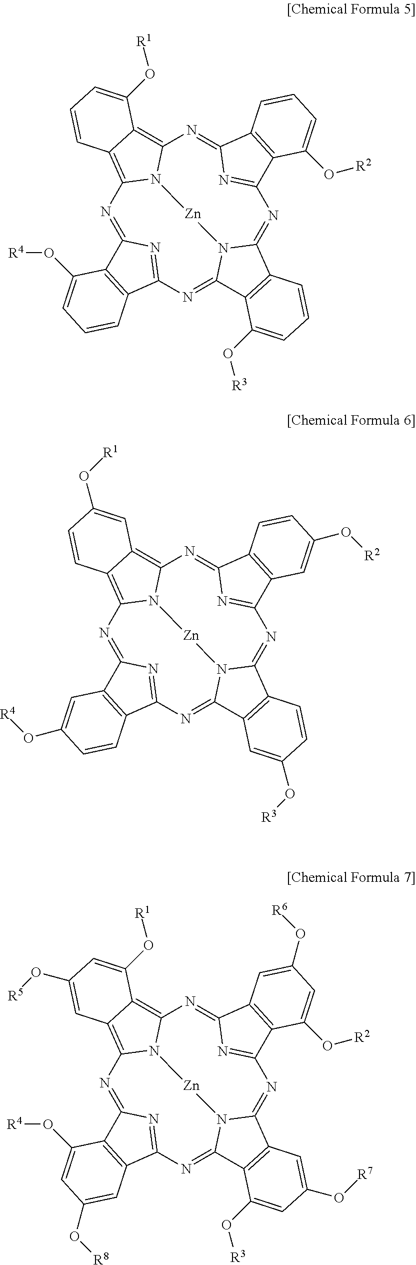

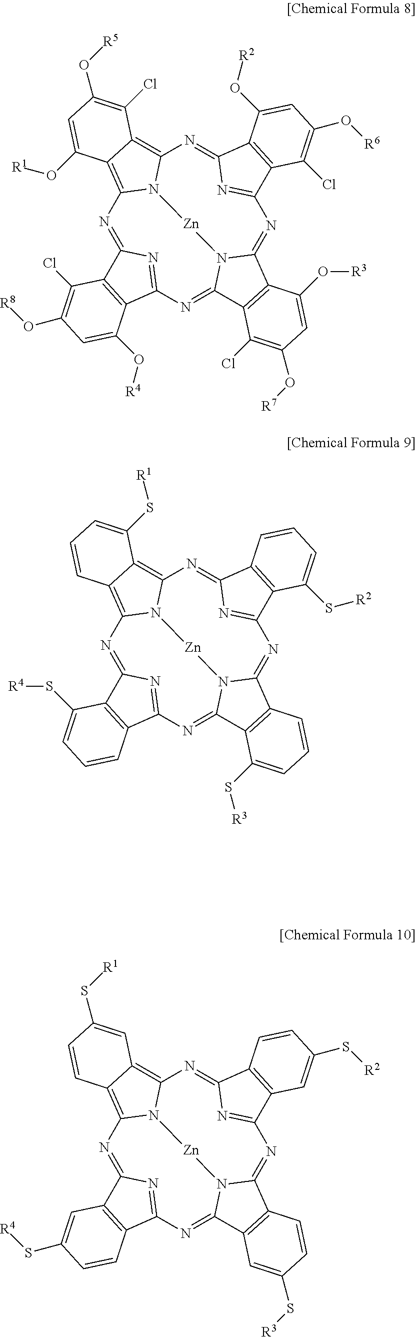

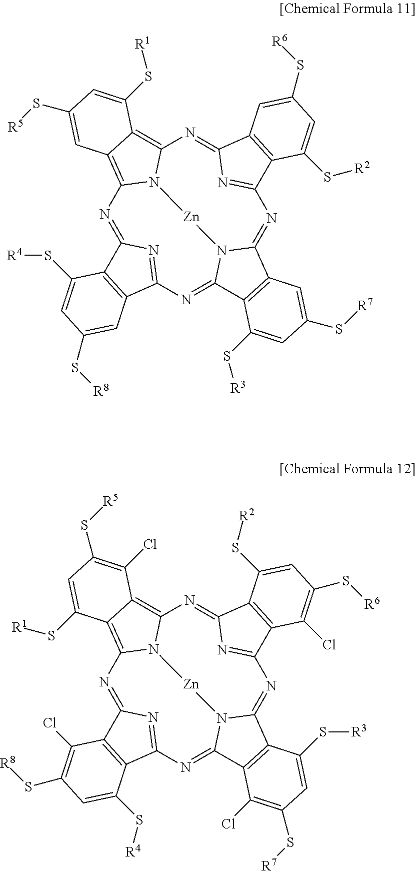

In Chemical Formulas 5 to 12,

R¹ to R⁸ are each independently represented by Chemical Formula 2.

The compound represented by Chemical Formula 2 may be represented by the following Chemical Formula 13 or 14.

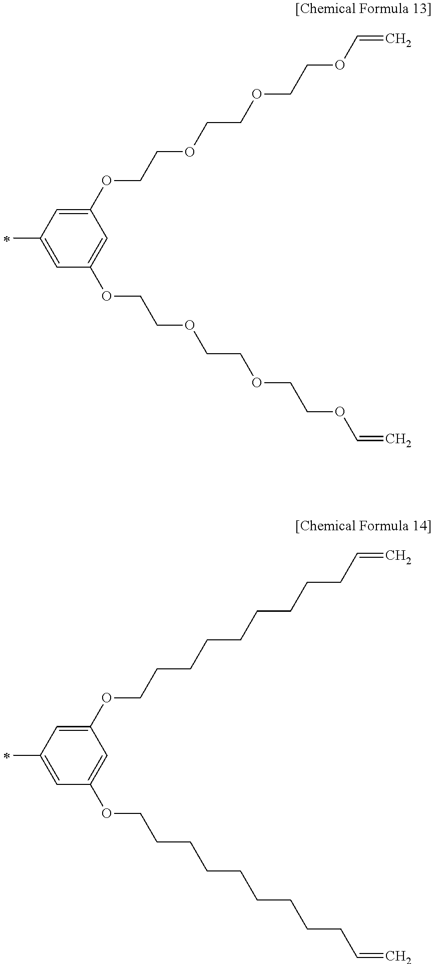

The compound may be a green dye.

The green dye may have a maximum absorbance in a wavelength range of 625 nanometers to 680 nanometers.

Another exemplary embodiment of the present invention provides a photosensitive resin composition for a color filter comprising the compound as described above.

Yet another exemplary embodiment of the present invention provides a color filter manufactured using the photosensitive resin composition as described above.

Details of embodiments of the present invention will be described below.

The compound according to an embodiment of the present invention exhibits excellent green spectra characteristics, high molar absorption coefficient, and excellent solubility in an organic solvent, such that the compound may be applied as a dye when preparing a photosensitive resin composition for a green color filter, and a color filter comprising the dye may exhibit excellent luminance and contrast ratio.

### DETAILED DESCRIPTION OF THE EMBODIMENTS

Hereinafter, exemplary embodiments of the present invention will be described in detail. However, the embodiments are described for illustrative purposes only, and the present invention is not limited thereto. Therefore, the present invention is intended to cover variations and modifications included within the spirit and scope of the appended claims to be described below. In the present specification, unless a specific definition is otherwise provided, the terms “substitution” and “substituted” when referred to in a functional group of the present invention, at least one hydrogen atom is substituted with at least one substituent selected from the group consisting of a halogen atom (F, Br, Cl ,or I), a hydroxyl group, a nitro group, a cyano group, an amino group (NH₂, NH(R²⁰⁰), or N(R²⁰¹)(R²⁰²), wherein R²⁰⁰, R²⁰¹, and R²⁰² are the same as or different from each other and are each independently C1 to C10 alkyl group), an amidino group, a hydrazine group, a hydrazone group, a carboxylic group, a substituted or unsubstituted alkyl group, a substituted or unsubstituted alkenyl group, a substituted or unsubstituted alkynyl group, a substituted or unsubstituted aliphatic organic group, a substituted or unsubstituted aryl group, and a substituted or unsubstituted heterocyclic group.

In the present specification, unless a specific definition is otherwise provided, the term “alkyl group” refers to a C1 to C20 alkyl group, specifically, a C1 to C15 alkyl group, the term “cycloalkyl group” refers to a C3 to C20 cycloalkyl group, specifically, a C3 to C18 cycloalkyl group, the term “alkoxy group” refers to a C1 to C20 alkoxy group, specifically, a C1 to C18 alkoxy group, the term “aryl group” refers to a C6 to C20 aryl group, specifically, a C6 to C18 aryl group, the term “alkenyl group” refers to a C2 to C20 alkenyl group, specifically, a C2 to C18 alkenyl group, the term “alkylene group” refers to a C1 to C20 alkylene group, specifically, a C1 to C18 alkylene group, and the term “arylene group” refers to a C6 to C20 arylene group, specifically, a C6 to C16 arylene group.

In the present specification, unless a specific definition is otherwise provided, the term “(meth)acrylate” refers to both “acrylate” and “methacrylate”, and the term “(meth)acrylic acid” refers to both “acrylic acid” and “methacrylic acid”.

In the present specification, unless a specific definition is otherwise provided, the term “combination” refers to a mixture or copolymerization. In addition, the term “copolymerization” refers to a block copolymerization or random copolymerization, and the term “copolymer” refers to a block copolymer or random copolymer.

In the present specification, unless a specific definition is otherwise provided, in the case in which a chemical bond is not drawn at a position at which the chemical bond needs to be shown, a hydrogen atom is bonded at the position.

Further, unless a specific definition is otherwise provided, “*” indicates a point where the same or different atom or chemical formula is linked.

An exemplary embodiment provides a compound represented by the following Chemical Formula 1.

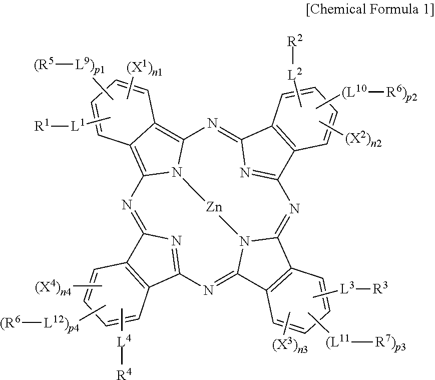

In Chemical Formula 1,

L¹ to L⁴ and L⁹ to L¹² are each independently —O— or —S—,

X¹ to X⁴ are each independently F or Cl,

n1 to n4 are each independently an integer of 0 or 1,

p1 to p4 are each independently an integer of 0 or 1, and

R¹ to R⁸ are each independently represented by the following Chemical

Formula 2,

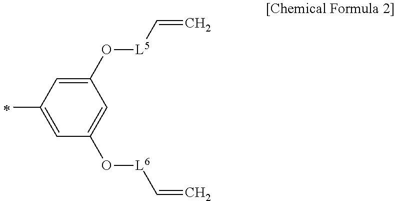

in Chemical Formula 2,

L⁵ and L⁶ are each independently a substituted or unsubstituted C1 to C20 alkylene group or divalent substituted or unsubstituted C1 to C20 alkylether group.

For example, L⁵ and L⁶ may be each independently a substituted or unsubstituted methylene group, a substituted or unsubstituted ethylene group, a substituted or unsubstituted propylene group, a substituted or unsubstituted butylene group, a substituted or unsubstituted pentylene group, a substituted or unsubstituted hexylene group, a substituted or unsubstituted heptylene group, a substituted or unsubstituted octylene group, a substituted or unsubstituted nonylene group, a substituted or unsubstituted decylene group, a divalent substituted or unsubstituted methylether group, a divalent substituted or unsubstituted ethylether group, a divalent substituted or unsubstituted propylether group, a divalent substituted or unsubstituted butylether group, a divalent substituted or unsubstituted pentylether group, a divalent substituted or unsubstituted hexylether group, a divalent substituted or unsubstituted heptylether group, a divalent substituted or unsubstituted octylether group, a divalent substituted or unsubstituted nonylether group, or a divalent substituted or unsubstituted decylether group, but are not limited thereto.

The compound represented by Chemical Formula 1 includes substituents having bulky dendritic structure and has excellent green spectrum characteristics and high molar absorption coefficient. In detail, the compound may include fluorine (F) or chlorine (Cl) as the substituent, and also include an ether linking group or sulfide linking group, which is an electron donating group, in a parent phthalocyanine, thereby making it possible to shift an absorption peak of the compound to a long wavelength. Further, the compound includes a double bond at an end of the substituents, such that the compound may be easily bonded to a binder resin constituting a photosensitive resin composition for a color filter, such that the durability of a dye itself may also be improved.

L⁵ and L⁶ may be each independently represented by the following Chemical Formula 3 or 4.

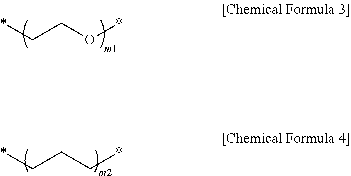

In Chemical Formulas 3 and 4,

m1 and m2 are each independently an integer of 1 to 6.

A phthalocyanine-based compound according to an exemplary embodiment of the present invention has a substituent including the linking group represented by Chemical Formula 3 or 4, such that solubility in an organic solvent such as propylene glycol methyl ether acetate (PGMEA), or the like, becomes excellent.

For example, ml and m2 may be each independently integers of 3 to 6.

The compound represented by Chemical Formula 1 may be represented by any one selected from the group consisting of the following Chemical

Formulas 5 to 12, but is not limited thereto.

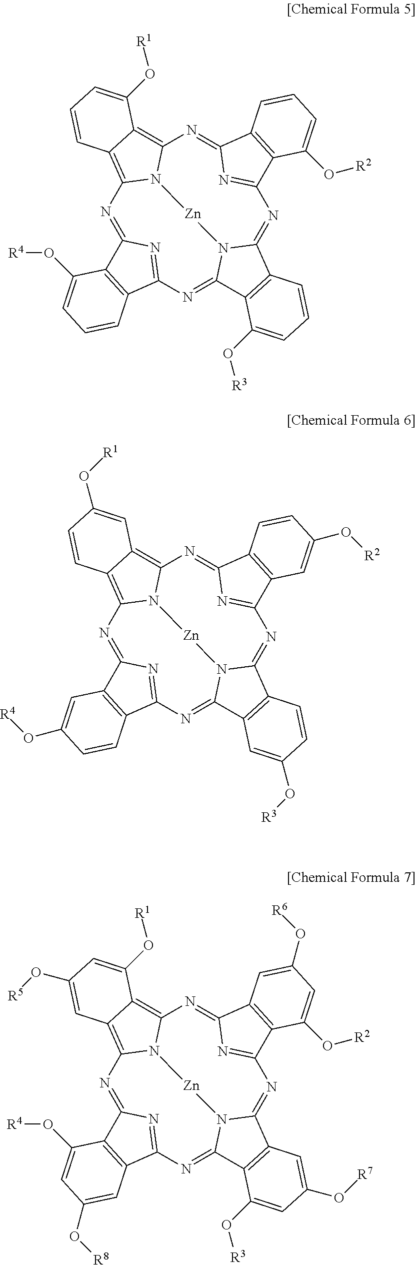

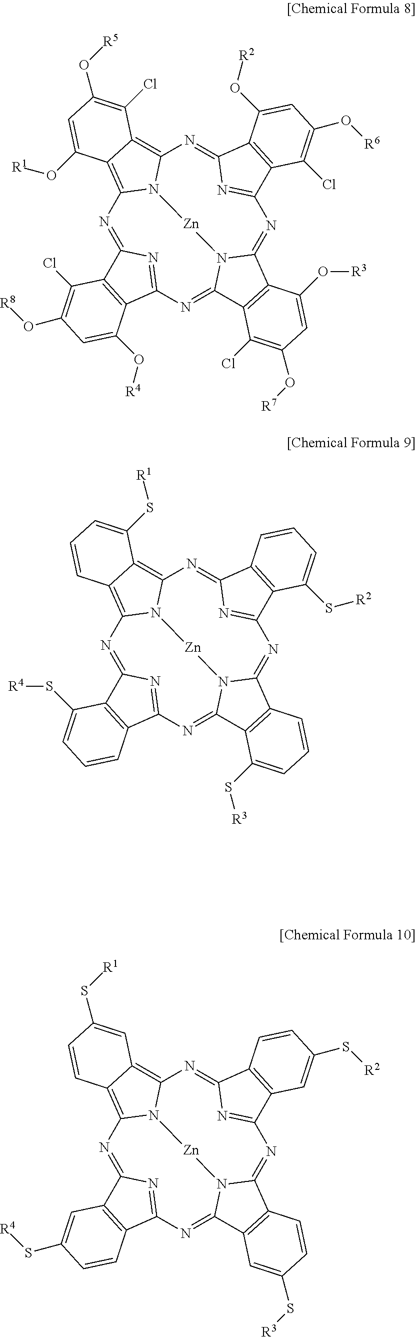

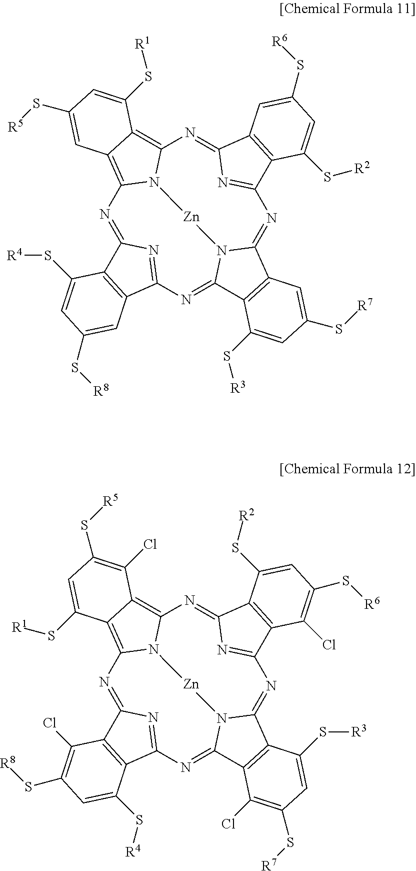

In Chemical Formulas 5 to 12,

R¹ to R⁸ are each independently represented by Chemical Formula 2.

The compound represented by Chemical Formula 2 may be represented by the following Chemical Formula 13 or 14.

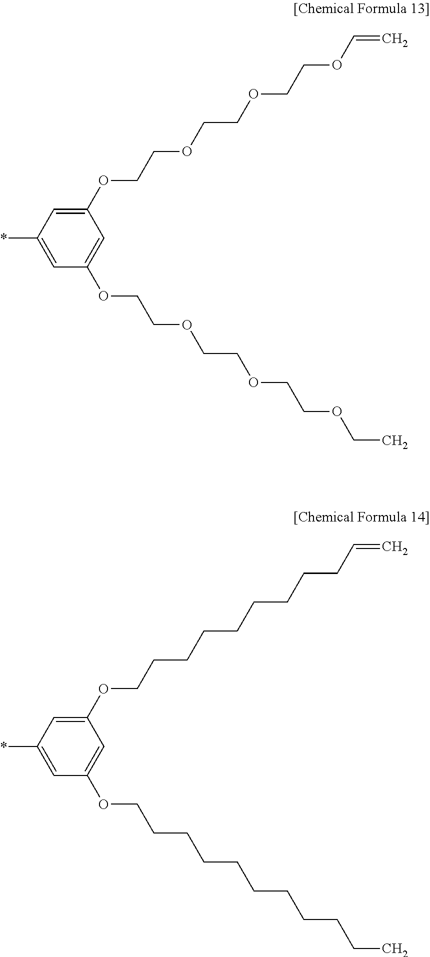 [SMILES: *c1cc(OCCOCCOCCOC=C)cc(OCCOCCOCCOCC)c1 ; *c1cc(OCCCCCCCCCC=C)cc(OCCCCCCCCCCC)c1]

Since the compound according to an exemplary embodiment of the present invention includes Chemical Formula 1 with substituents represented by Chemical Formula 2, a more vivid color may be implemented even with a small amount, and when using the compound as a coloring agent, a color filter having excellent color characteristics such as luminance, contrast ratio, or the like, may be manufactured. For example, the compound may be a coloring agent, for example, a dye, for example, a green dye, for example, a dye having a maximum absorbance in a wavelength range of 625 nanometers to 680 nanometers.

In general, a dye is the most expensive component among components used in a color filter. Therefore, since there was a need to use a large amount of an expensive dye in order to achieve the desired effect, for example, high luminance, a high contrast ratio, or the like, the production cost inevitably increased. However, in the case of using the compound according to an exemplary embodiment as a dye in a color filter, excellent color characteristics such as high luminance, a high contrast ratio, or the like, may be achieved even with a small amount of dye, thereby making it possible to decrease production cost.

Further, the compound according to an exemplary embodiment of the present invention may further include fluorine (F) or chlorine (Cl) as a substituent in addition to the substituents represented by Chemical Formula 2. In this case, an absorption peak wavelength may be further shifted to a longer wavelength.

Another exemplary embodiment of the present invention provides a photosensitive resin composition for a color filter comprising the compound as described above.

For example, the photosensitive resin composition for a color filter may comprise the compound according to an exemplary embodiment, a binder resin, a photopolymerizable compound, a photopolymerization initiator, and a solvent, and may further comprise a pigment.

The compound according to an exemplary embodiment may serve as a coloring agent, for example, a dye, for example, a green dye, in the photosensitive resin composition, thereby making it possible to exhibit excellent color characteristics.

The binder resin may be an acrylic resin.

The acrylic resin, which is a copolymer of a first ethylenically unsaturated monomer and a second ethylenically unsaturated monomer therewith, is a resin comprising at least one acrylic repeating unit.

The first ethylenically unsaturated monomer is an ethylenically unsaturated monomer comprise at least one carboxyl group, and a specific example thereof may include an acrylic acid, methacrylic acid, maleic acid, itaconic acid, fumaric acid, or a combination thereof.

The first ethylenically unsaturated monomer may be included at a content of 5 wt % to 50 wt %, for example, 10 wt % to 40 wt %, based on a total weight of the acrylic binder resin.

The second ethylenically unsaturated monomer may be an aromatic vinyl compound such as styrene, α-methylstyrene, vinyltoluene, vinylbenzylmethylether, or the like; an unsaturated carboxylic acid ester compound such as methyl(meth)acrylate, ethyl(meth)acrylate, butyl(meth)acrylate, 2-hydroxyethyl(meth)acrylate, 2-hydroxy butyl(meth)acrylate, benzyl(meth)acrylate, cyclohexyl(meth)acrylate, phenyl(meth)acrylate, or the like; an unsaturated carboxylic acid amino alkyl ester compound such as 2-aminoethyl(meth)acrylate, 2-dimethylaminoethyl(meth)acrylate, or the like ; a carboxylic acid vinyl ester compound such as vinyl acetate, vinyl benzoate, or the like; an unsaturated carboxylic acid glycidyl ester compound such as glycidyl(meth)acrylate, or the like; a vinyl cyanide compound such as (meth)acrylonitrile, or the like; an unsaturated amide compound such as (meth)acrylamide, or the like. One of the second ethylenically unsaturated monomers may be used alone or a mixture of at least two thereof may be used.

Specific examples of the acrylic resin may include a (meth)acrylic acid/benzylmethacrylate copolymer, a (meth)acrylic acid/benzylmethacrylate/styrene copolymer, a (meth)acrylic acid/benzylmethacrylate/2-hydroxyethylmethacrylate copolymer, a (meth)acrylic acid/benzylmethacrylate/styrene/2-hydroxyethylmethacrylate copolymer, but are not limited thereto. One of the acrylic resins may be used alone or a combination of at least two thereof may also be used.

The binder resin may have a weight average molecular weight of 3,000 g/mol to 150,000 g/mol, for example 5,000 g/mol to 50,000 g/mol, for example 20,000 g/mol to 30,000 g/mol. In the case in which the weight average molecular weight of the binder resin is in the above-mentioned range, the photosensitive resin composition exhibits excellent physical and chemical properties, a suitable viscosity, and an excellent adhesion property to a substrate at the time of manufacturing a color filter.

An acid value of the binder resin may be 15 mg KOH/g to 60 mg KOH/g, for example, 20 mg KOH/g to 50 mg KOH/g. In the case in which an acid value of an alkali-soluble resin is in the above-mentioned range, the resolution of a pixel pattern is excellent.

A monofunctional or multifunctional (meth)acrylic acid ester having at least one ethylenically unsaturated double bond may be used as the photopolymerizable compound,. A multifunctional photopolymerizable compound comprises more than one functional group that participates in a polymerization reaction.

The photopolymerizable compound comprises the ethylenically unsaturated double bonds to perform a sufficient polymerization reaction during the time of light exposure in a process of forming a pattern, such that a pattern having excellent heat resistance, light resistance, and chemical resistance may be formed.

Specific examples of the photopolymerizable compound may include ethylene glycol di(meth)acrylate, diethylene glycol di(meth)acrylate, triethylene glycol di(meth)acrylate, propylene glycol di(meth)acrylate, neopentyl glycol di(meth)acrylate, 1,4-butandiol di(meth)acrylate, 1,6-hexanediol di(meth)acrylate, bisphenol A di(meth)acrylate, pentaerythritol di(meth)acrylate, pentaerythritol tri(meth)acrylate, pentaerythritol tetra(meth)acrylate, pentaerythritol hexa(meth)acrylate, dipentaerythritol di(meth)acrylate, dipentaerythritol tri(meth)acrylate, dipentaerythritol penta(meth)acrylate, dipentaerythritol hexa(meth)acrylate, bisphenol A epoxy(meth)acrylate, ethylene glycol monomethylether (meth)acrylate, trimethylol propane tri(meth)acrylate, tris(meth)acryloyloxyethyl phosphate, novolac epoxy (meth)acrylate, and the like.

Examples of commercially available photopolymerizable compounds are as follows. Examples of the monofunctional (meth)acrylic acid esters may include ARONIX M-101®, ARONIX M-111®, ARONIX M-114®, and the like, (Toagosei Chemical Industry Co., Inc.); KAYARAD TC-110S®, KAYARAD TC-120S®, and the like, (Nippon Kayaku Co. Ltd.); and V-158®, V-2311®, and the like (Osaka Organic Chemical Industry Ltd.). Examples of the difunctional (meth)acrylic acid ester may include—ARONIX M-210®, ARONIX M-240®, ARONIX M-6200®, and the like, (Toagosei Chemical Industry Co., Inc.); KAYARAD HDDA®, KAYARAD HX-220®, KAYARAD R-604®, and the like, (Nippon Kayaku Co. Ltd.); and V-260®, V-312®, V-335 HP®, and the like (Osaka Organic Chemical Industry Ltd.). Examples of trifunctional (meth)acrylic acid esters may include ARONIX M-309®, ARONIX M-400®, ARONIX M-405®, ARONIX M-450®, ARONIX M-710®, ARONIX M-8030®, ARONIX M-8060®, and the like, (Toagosei Chemical Industry Co., Inc.); KAYARAD TMPTA®, KAYARAD DPCA-20®, KAYARAD DPCA-30®, KAYARAD DPCA-60®, KAYARAD DPCA-120®, and the like, (Nippon Kayaku Co. Ltd.); and V-295®, V-300®, V-360®, V-GPT®, V-3PA®, V-400®, and the like (Osaka Organic Chemical Industry Ltd.). One of the photopolymerizable compounds may be used alone or at least two thereof may be used together.

In order to impart improved developing properties, the photopolymerizable compound may be treated with acid anhydride and then used.

The photopolymerization initiator is an initiator generally used in photosensitive resin compositions. For example, an acetophenone-based compound, a benzophenone-based compound, a thioxanthone-based compound, a benzoin-based compound, a triazine-based compound, an oxime-based compound, or a combination thereof may be used. A compound that is described using the suffix “-based” added to a known chemical group is a compound that comprises that known chemical group, substituted or unsubstituted. Thus, a benzophenone-based compound is a compound that comprises an unsubstituted benzophenone group or a substituted benzophenone group.

Examples of the acetophenone-based compound may include 2,2′-diethoxy acetophenone, 2,2′-dibutoxy acetophenone, 2-hydroxy-2-methylpropiophenone, p-tert-butyl-2,2,2-trichloro acetophenone, p-tert-butyldichloro acetophenone, 4-chloro acetophenone, 2,2′-dichloro-4-phenoxy acetophenone, 2-methyl-1-(4-(methylthio)phenyl)-2-morpholinopropan-1-one, 2-benzyl-2-dimethylamino-1-(4-morpholinophenyl)-butan-1-one, and the like.

Examples of the benzophenone-based compound may include benzophenone, benzyl benzoate, methyl-2-benzoyl benzoate, 4-phenyl benzophenone, hydroxy benzophenone, acrylated benzophenone, 4,4′-bis (dimethylamino)benzophenone, 4,4′-bis (diethylamino)benzophenone, 4,4′-dimethylaminobenzophenone, 4,4′-dichlorobenzophenone, 3,3′-dimethyl-2-methoxybenzophenone, and the like.

Examples of the thioxanthone-based compound may include thioxanthone, 2-methylthioxanthone, isopropyl thioxanthone, 2,4-diethyl thioxanthone, 2,4-diisopropyl thioxanthone, 2-chlorothioxanthone, and the like.

Examples of the benzoin-based compound may include benzoin, benzoin methyl ether, benzoin ethyl ether, benzoin isopropyl ether, benzoin isobutyl ether, benzyldimethylketal, and the like.

Examples of the triazine-based compound may include 2,4,6-trichloro-s-triazine, 2-phenyl 4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis (trichloromethyl)-s-triazine, 2-(p-tolyl)-4,6-bis (trichloro methyl)-s-triazine, 2-biphenyl 4,6-bis(trichloro methyl)-s-triazine, bis(trichloromethyl)-6-styryl-s-triazine, 2-(naphtho-1-yl)-4,6-bis(trichloromethyl)-s-triazine, 2-(4-methoxynaphtho-1-yl)-4,6-bis(trichloromethyl)-s-triazine, 2-4-bis (trichloromethyl)-6-piperonyl-s-triazine, 2-4-bis (trichloromethyl)-6-(4-methoxystyryl)-s-triazine, and the like.

Examples of the oxime-based compound may include an O-acyloxime-based compound, 2-(o-benzoyloxime)-1-[4-(phenylthio)phenyl]-1,2-octanedione, 1-(o-acetyloxime)-1-[9-ethyl-6-(2-methylbenzoyl)-9H-carbazol-3-yl]ethanone, O-ethoxycarbonyl-α-oxyamino-1-phenylpropan-1-one, and the like. Specific examples of the O-acyloxime-based compound may include 1,2-octanedione, 2-dimethylamino-2-(4-methylbenzyl)-1-(4-morpholin-4-yl-phenyl)-butan-1-one, 1-(4-phenylsulfanylphenyl)-butan-1,2-dione-2-oxime-O-benzoate, 1-(4-phenylsulfanylphenyl)-octan-1,2-dione-2-oxime-O-benzoate, 1-(4-phenylsulfanylphenyl)-octan-1-one oxime-O-acetate, 1-(4-phenylsulfanylphenyl)-butan-1-one oxime-O-acetate, and the like.

As the photopolymerization initiator, a carbazole-based compound, a diketone-based compound, a sulfonium borate-based compound, a diazo-based compound, an imidazole-based compound, a biimidazole-based compound, and the like, as well as any of the above-mentioned compounds, may be used.

The photopolymerization initiator may be used together with a photosensitizer capable of causing a chemical reaction by absorbing light and becoming excited and then transferring its energy.

Examples of the photosensitizer may include tetraethylene glycol bis-3-mercapto propionate, pentaerythritol tetrakis-3-mercapto propionate, dipentaerythritol tetrakis-3-mercapto propionate, and the like.

A material which has compatibility with the compound according to an exemplary embodiment, the binder resin, the photopolymerizable compound, the photopolymerization initiator, and/or the pigment, but does not react therewith may be used as the solvent.

Examples of the solvent may include alcohols such as methanol, ethanol, and the like; ethers such as dichloroethyl ether, n-butyl ether, diisoamyl ether, methylphenyl ether, tetrahydrofuran, and the like; glycol ethers such as ethylene glycol monomethylether, ethylene glycol monoethylether, and the like; CELLOSOLVE™ acetates (available from Dow Chemical Co.) such as methyl CELLOSOLVE™ acetate, ethyl CELLOSOLVE™ acetate, diethyl CELLOSOLVE™ acetate, and the like; CARBITOL™ solvents (available from Dow Chemical Co.) such as methylethyl CARBITOL™, diethyl CARBITOL™, diethylene glycol monomethylether, diethylene glycol monoethylether, diethylene glycol dimethylether, diethylene glycol methylethylether, diethylene glycol diethylether, and the like; propylene glycol alkylether acetates such as propylene glycol methylether acetate, propylene glycol propylether acetate, and the like; aromatic hydrocarbons such as toluene, xylene and the like; ketones such as methylethylketone, cyclohexanone, 4-hydroxy-4-methyl-2-pentanone, methyl-n-propylketone, methyl-n-butylketone, methyl-n-amylketone, 2-heptanone, and the like; saturated aliphatic monocarboxylic acid alkyl esters such as ethyl acetate, n-butyl acetate, isobutyl acetate, and the like; lactate esters such as methyl lactate, ethyl lactate, and the like; oxy acetic acid alkyl esters such as oxy methyl acetate, oxy ethyl acetate, oxy butyl acetate, and the like; alkoxy acetic acid alkyl esters such as methoxy methyl acetate, methoxy ethyl acetate, methoxy butyl acetate, ethoxy methyl acetate, ethoxy ethyl acetate, and the like; 3-oxy propionic acid alkyl esters such as 3-oxy methyl propionate, 3-oxy ethyl propionate, and the like; 3-alkoxy propionic acid alkyl esters such as 3-methoxy methyl propionate, 3-methoxy ethyl propionate, 3-ethoxy ethyl propionate, 3-ethoxy methyl propionate, and the like; 2-oxy propionic acid alkyl esters such as 2-oxy methyl propionate, 2-oxy ethyl propionate, 2-oxy propyl propionate, and the like; 2-alkoxy propionic acid alkyl esters such as 2-methoxy methyl propionate, 2-methoxy ethyl propionate, 2-ethoxy ethyl propionate, 2-ethoxy methyl propionate, and the like; 2-oxy-2-methyl propionic acid esters such as 2-oxy-2-methyl methyl propionate, 2-oxy-2-methyl ethyl propionate, and the like, monooxy monocarboxylic acid alkyl esters of 2-alkoxy-2-methyl alkyl propionates such as 2-methoxy-2-methyl methyl propionate, 2-ethoxy-2-methyl ethyl propionate, and the like; esters such as 2-hydroxy ethyl propionate, 2-hydroxy-2-methyl ethyl propionate, hydroxy ethyl acetate, 2-hydroxy-3-methyl methyl butanoate, and the like; ketonate esters such as ethyl pyruvate, and the like. Additionally, high boiling point solvents such as N-methylformamide, N,N-dimethylformamide, N-methylformanilide, N-methylacetamide, N,N-dimethylacetamide, N-methylpyrrolidone, dimethylsulfoxide, benzylethylether, dihexylether, acetylacetone, isophorone, caproic acid, caprylic acid, 1-octanol, 1-nonanol, benzylalcohol, benzyl acetate, ethyl benzoate, diethyl oxalate, diethyl maleate, y-butyrolactone, ethylene carbonate, propylene carbonate, phenyl CELLOSOLVE™ acetate, and the like may be also used.

Among the solvents, the glycol esters such as ethylene glycol monoethylether, and the like; the ethylene glycol alkylether acetates such as ethyl CELLOSOLVE™ acetate, and the like; the esters such as 2-hydoxy ethyl propionate, and the like; the CARBITOL™ solvents such as diethylene glycol monomethylether, and the like; and the propylene glycol alkyl ether acetates such as propylene glycol monomethyl ether acetate, propylene glycol propylether acetate, and the like, may be preferably used in consideration of compatibility and reactivity.

The photosensitive resin composition for a color filter according to another exemplary embodiment of the present invention may further comprise an epoxy compound in order to improve a close adhesion property to a substrate, or the like.

Examples of the epoxy compound may include a phenol novolac epoxy compound, a tetramethyl biphenyl epoxy compound, a bisphenol A type epoxy compound, an aliphatic epoxy compound, or a combination thereof.

In addition, the photosensitive resin composition for a color filter according to another exemplary embodiment of the present invention may further comprise a silane coupling agent having a reactive substituent such as a carboxylic group, a methacryloyl group, an isocyanate group, an epoxy group, and the like, in order to improve an adhesion property to a substrate.

Examples of the silane coupling agent may include trimethoxysilyl benzoic acid, γ-methacryl oxypropyl trimethoxysilane, vinyl triacetoxysilane, vinyl trimethoxysilane, γ-isocyanate propyl triethoxysilane, γ-glycidoxy propyl trimethoxysilane, β-(3,4-epoxycyclohexyl)ethyltrimethoxysilane, and the like. One of the silane coupling agents may be used alone or a mixture of at least two thereof may be used.

Further, if necessary, the photosensitive resin composition for a color filter according to another exemplary embodiment of the present invention may further comprise a surfactant in order to improve coating properties and to prevent defects from being generated.

Examples of the surfactant may include commercial fluorine-based surfactant such as BM-1000®, BM-1100®, and the like (BM Chemie Inc.); MEGAFACE F 142D®, MEGAFACE F 172®, MEGAFACE F 173®, MEGAFACE F 183®, and the like (Dainippon Ink Kagaku Kogyo Co., Ltd.); FLUORAD FC-135®, FLUORAD FC-170C®, FLUORAD FC-430®, and FLUORAD FC-431®, and the like (Sumitomo 3M Co., Ltd.); SURFLON S-112®, SURFLON S-113®, SURFLON S-131®, SURFLON S-141®, and SURFLON S-145®, and the like (Asahi Glass Co., Ltd.); and SH-28PA®, SH-190®, SH-193®, SZ-6032®, and SF-8428®, and the like (Toray Silicone Co., Ltd.), and the like.

In addition, the photosensitive resin composition for a color filter according to another exemplary embodiment of the present invention may further comprise other additives such as an antioxidant, a stabilizer, and the like, within a predetermined content range in which the physical properties thereof are not deteriorated.

Another exemplary embodiment of the present invention provides a color filter manufactured using the photosensitive resin composition for a color filter.

A process of forming a pattern in the color filter is as follows.

The process comprises a process of applying the photosensitive resin composition for a color filter on a support substrate by spin coating, slit coating, inkjet printing, or the like; a process of drying the applied photosensitive resin composition to form a photosensitive resin composition film; a process of exposing the formed photosensitive resin composition film to light; a process of developing the exposed photosensitive resin composition film with alkaline aqueous solution to manufacture a photosensitive resin film; and a process of heating the photosensitive resin film. Since the process conditions, and the like, are widely known in the art, a detailed description thereof will be omitted in the present specification.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A compound represented by the following Chemical Formula 1: 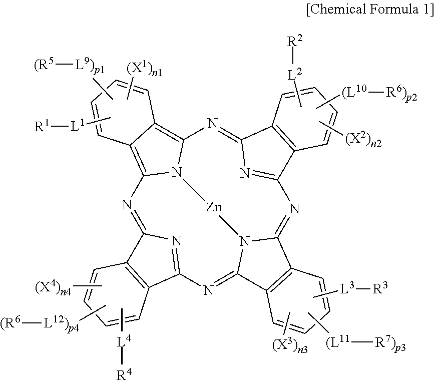
in Chemical Formula 1,
L¹ to L⁴ and L⁹ to L¹² are each independently —O— or —S—,
X¹ to X⁴ are each independently F or Cl,
n1 to n4 are each independently an integer of 0 or 1,
p1 to p4 are each independently an integer of 0 or 1, and
R¹ to R⁸ are each independently represented by the following Chemical Formula 2, 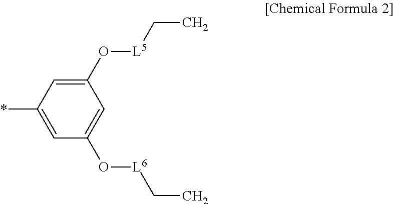
in Chemical Formula 2,
L⁵ and L⁶ are each independently a substituted or unsubstituted C1 to C20 alkylene group or divalent substituted or unsubstituted C1 to C20 alkylether group.

2. The compound of claim 1, wherein:
L⁵ and L⁶ are each independently represented by the following Chemical Formula 3 or 4: 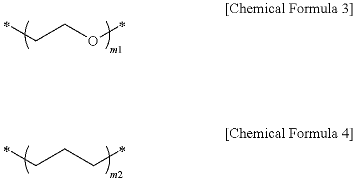
in Chemical Formulas 3 and 4,
m1 and m2 are each independently an integer of 1 to 6.

3. The compound of claim 2, wherein:
m1 and m2 are each independently an integer of 3 to 6.

4. The compound of claim 1, wherein:
the compound represented by Chemical Formula 1 is represented by any one selected from the group consisting of the following Chemical Formulas 5 to 12: 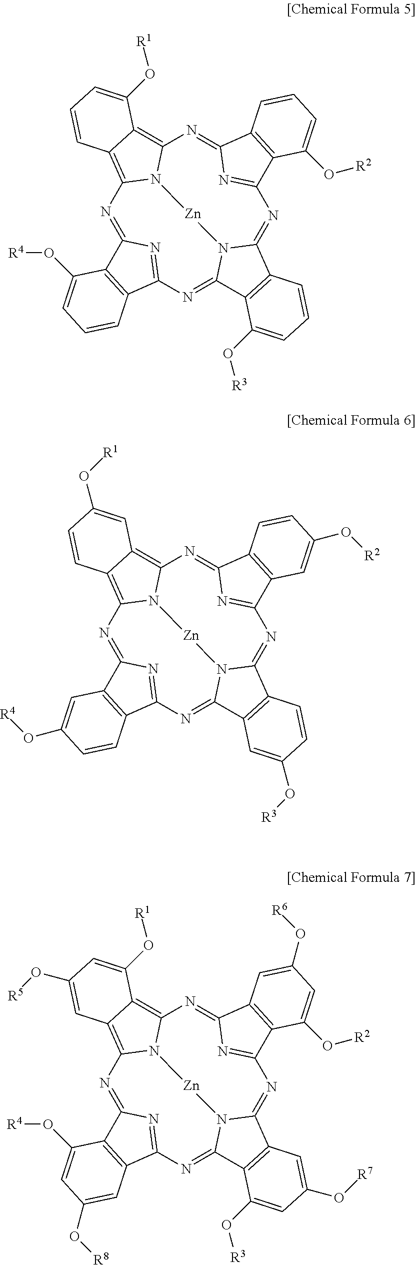 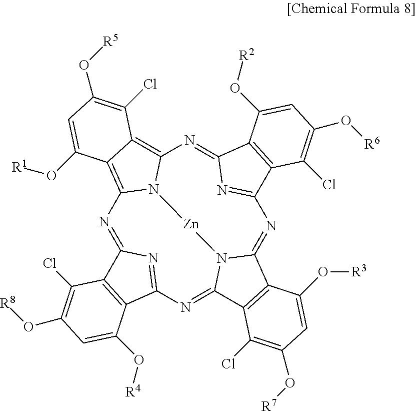
in Chemical Formulas 5 to 8,
R¹ to R⁸ are each independently represented by the following Chemical Formula 2, 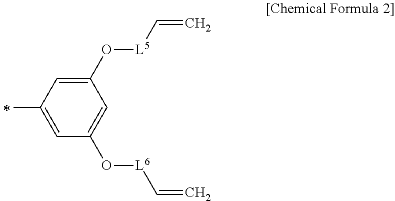
in Chemical Formula 2,
L⁵ and L⁶ are each independently a substituted or unsubstituted C1 to C20 alkylene group or divalent substituted or unsubstituted C1 to C20 alkylether group.

5. The compound of claim 1, wherein:
the compound represented by Chemical Formula 1 is represented by any one selected from the group consisting of Chemical Formulas 9 to 12: 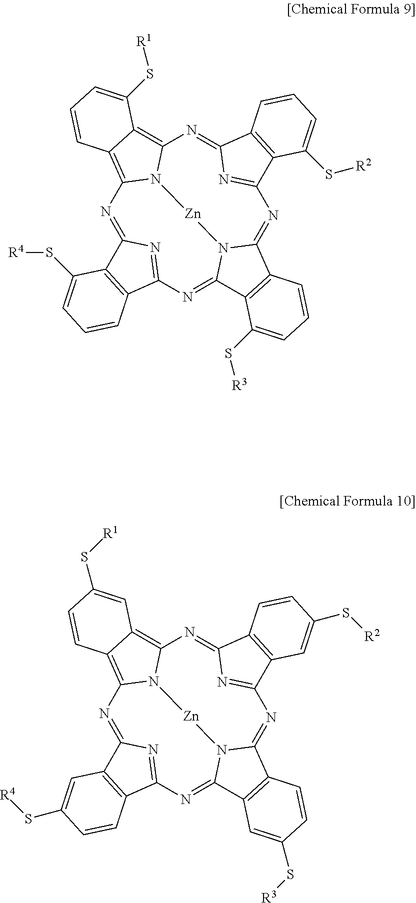 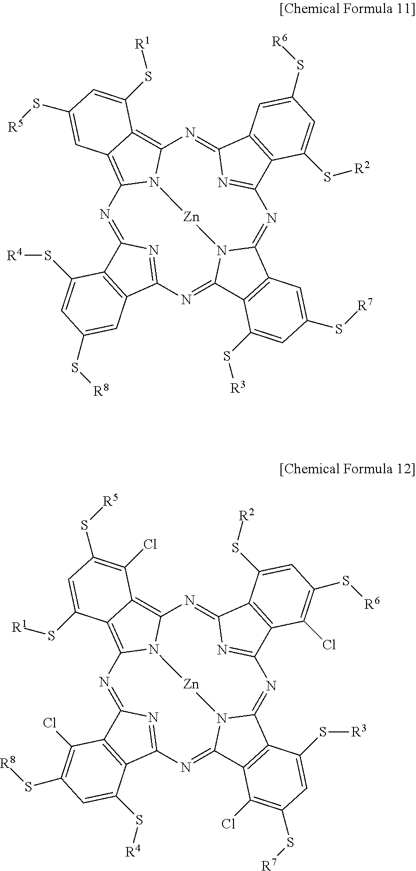
in Chemical Formulas 9 to 12,
R¹ to R⁸ are each independently represented by the following Chemical Formula 2, 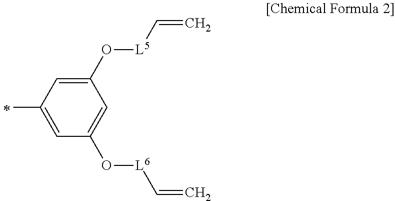
in Chemical Formula 2,
L⁵ and L⁶ are each independently a substituted or unsubstituted C1 to C20 alkylene group or divalent substituted or unsubstituted C1 to C20 alkylether group.

6. The compound of claim 4, wherein:
the compound represented by Chemical Formula 2 is represented by the following Chemical Formula 13 or 14.

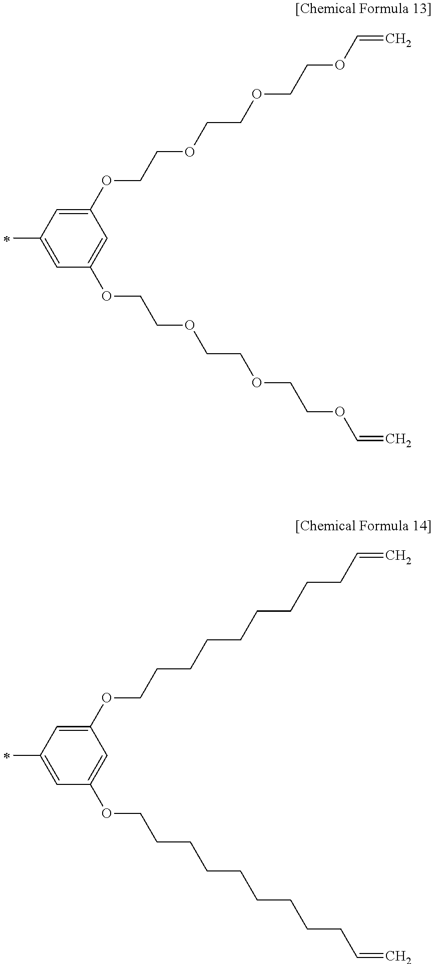

7. The compound of claim 5, wherein:
the compound represented by Chemical Formula 2 is represented by the following Chemical Formula 13 or 14.

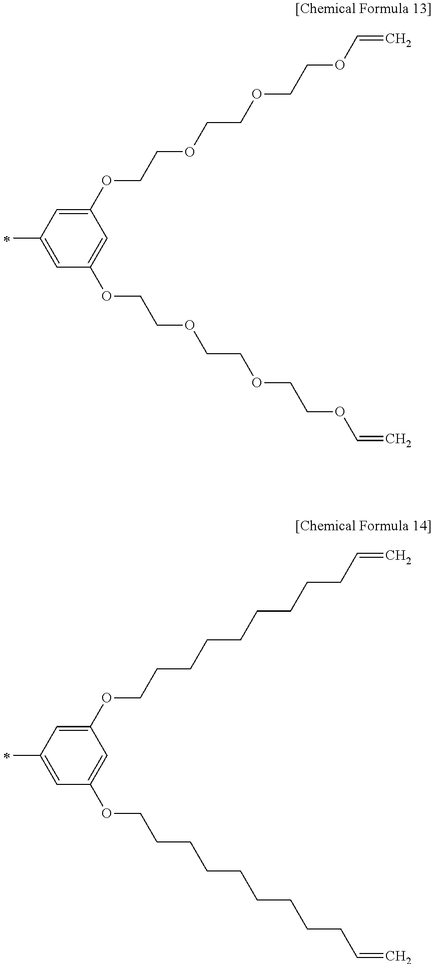

8. The compound of claim 1, wherein:
the compound serves as a green dye.

9. The compound of claim 8, wherein:
the green dye has a maximum absorbance in a wavelength range of 625 nanometers to 680 nanometers.

10. A photosensitive resin composition for a color filter, the composition comprising a compound represented by the following Chemical Formula 1: 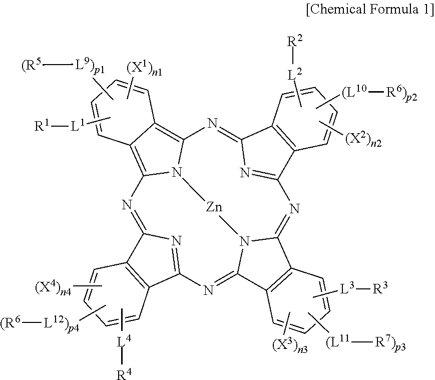
in Chemical Formula 1,
L¹ to L⁴ and L⁹ to L¹² are each independently —O— or —S—,
X¹ to X⁴ are each independently F or Cl,
n1 to n4 are each independently an integer of 0 or 1,
p1 to p4 are each independently an integer of 0 or 1, and
R¹ to R⁸ are each independently represented by the following Chemical Formula 2, 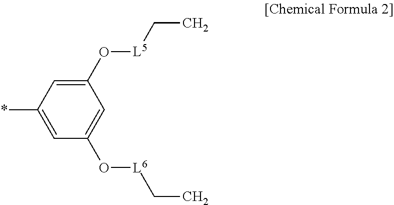
in Chemical Formula 2,
L⁵ and L⁶ are each independently a substituted or unsubstituted C1 to C20 alkylene group or divalent substituted or unsubstituted C1 to C20 alkylether group.

11. A color filter manufactured using the photosensitive resin composition for a color filter of claim 10.
